(19) United States
(12) Patent Application Publication
(10) Pub. No.: US 2004/0268210 A1
(43) Pub. Date: Dec. 30, 2004

(54) Online doctors appointment

(76) Inventor: Tariq Gul, Forest Hills, NY (US)

Correspondence Address: TARIQ GUL, APT. 10-B, 104-20 QUEENS BLVD., FOREST HILLS, NY, 11375, US

(21) Appl. No.: 10/460,107

(22) Filed: Jun. 12, 2003

(51) Int. Cl. G06F 17/00

(52) U.S. Cl. 715/500

(57) ABSTRACT

ONLINE DOCTORS APPOINTMENT is a real-time web application for doctors appointment. The application has three main sections. First section is the general information about doctor, contact information, etc. Second section is Patient Login, only the register people can login and make, cancel, reschedule appointment 24 hours a day 7 days a week or Modify information like address change, telephone change, etc. Third section is doctor login, only authorized staff can login. Modify information doctor, office, etc. print or View any day appointments. Make, cancel, and reschedule appointments. New patient, first register and get password and user name to make the appointment. The base application is one doctor one specialty, but it is flexible to be used by many doctors and many specialties. The database, store procedures and computer program is design in such way to accommodate different situation. The front end can be modified as per requirement. People only need an internet access to use the application.

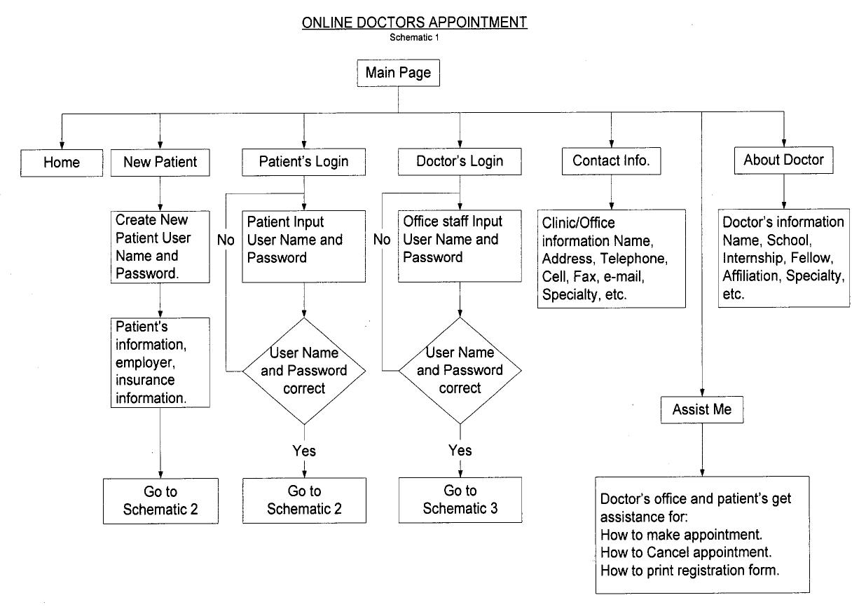

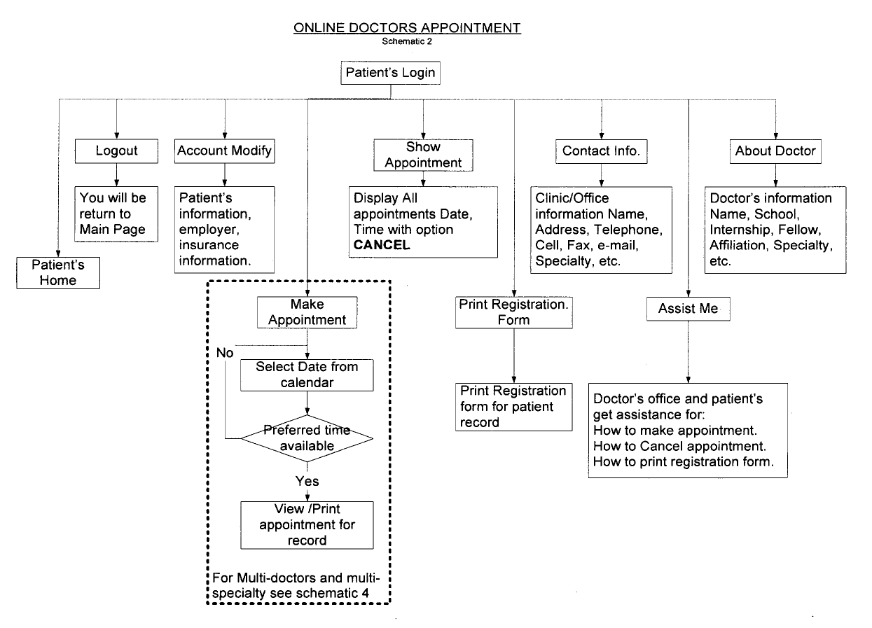

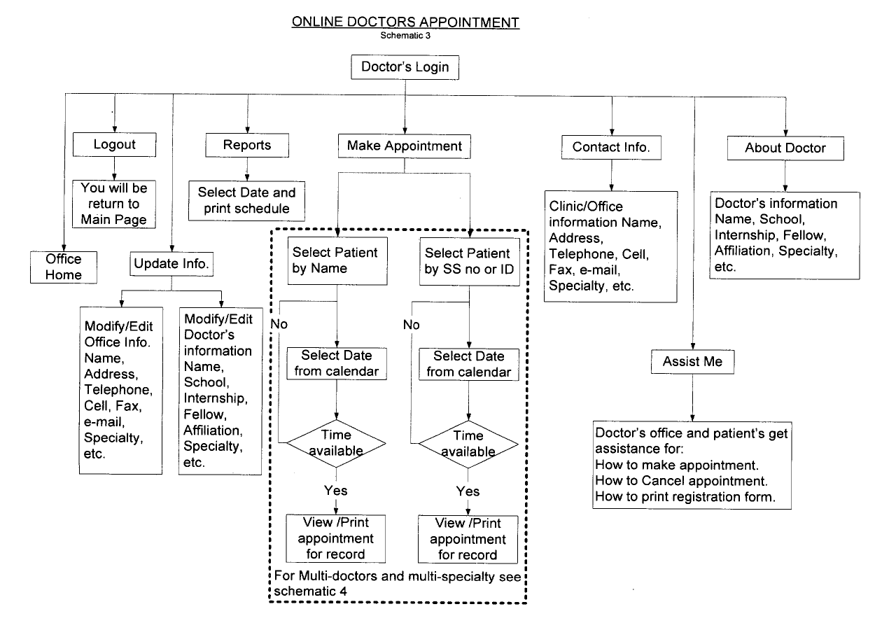

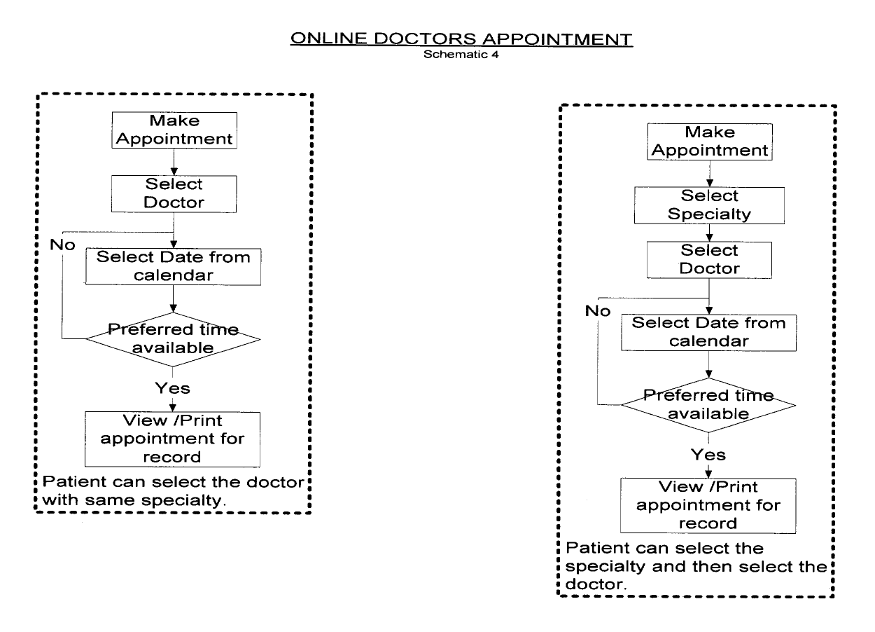

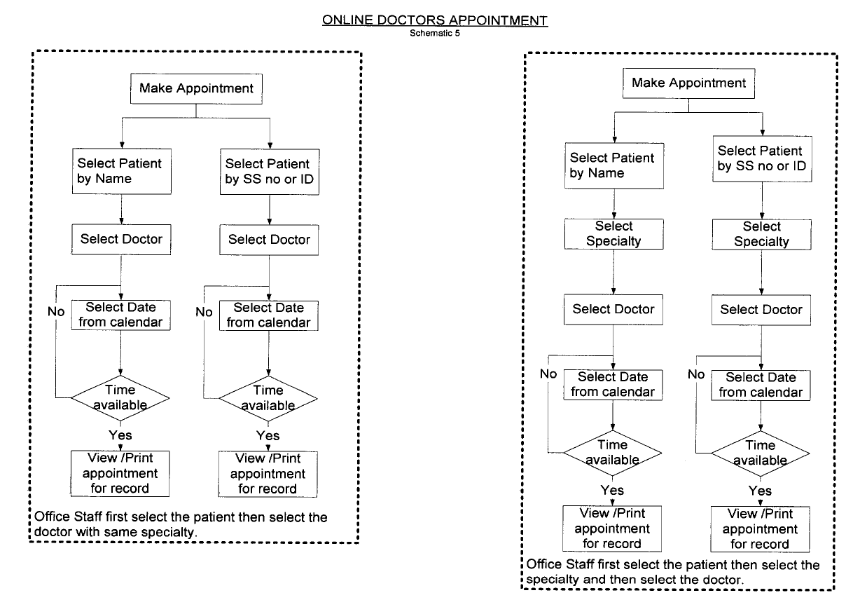

Reference to sequence listing, a table, or a computer program listing appendix See the Appendix I for screen shots, computer program and html.

### BACKGROUND OF THE INVENTION

People are having difficulty in making appointment with the doctor like telephone line is busy, office close, put on hold, etc. Therefore there is a need of some system which will take care of these issues and must be cost effective.

### BRIEF SUMMARY OF THE INVENTION

ONLINE DOCTORS APPOINTMENT is a real-time web based application. People can make doctors appointment 24 hours a day and 7 days a week. People can pick the desired day and time from doctor appointment calendar. Office staff can also make appointment during office hours. It is user friendly and little knowledge of web browsing can make doctors appointment.

### BRIEF DESCRIPTION OF THE DRAWINGS

There are 5 schematics in “ONLINE DOCTORS APPOINTMENT” application. The brief descriptions are as follows:

Schematic 1:

This is the starting point of the application. From here different users can go to the required area of the application. New patient can register. Register patient can login by using user name and password. Office staff can login by using user name and password. General area are Contact information, Assist me, and about doctor.

Schematic 2:

This is the starting point for register user. From here register users can go to the different area. Modify/Edit the information like home/work telephone number change, Insurance information, etc. View the current appointment(s). Cancel appointment. Make new appointment. General area are logout, Contact information, Assist me, and about doctor.

Schematic 3:

This is the starting point for office staff. From here the office staff can go to the different area. Modify/Edit the office information like telephone number change, address, etc. Modify/Edit the doctor information like telephone number change, specialty, etc. View the current appointment(s). Cancel appointment. Make new appointment. Print doctor appointment for a particular day. General area are logout, Contact information, Assist me, and about doctor.

Schematic 4:

This schematic is the extension of schematic 2. The register user can make appointment by first selecting a doctor. User can select the specialty first and then select a doctor before making an appointment.

Schematic 5:

This schematic is the extension of schematic 3. The office staff can make appointment by first giving a choice of doctors. Office staff can ask first the specialty and then give choice of doctors before making an appointment.

### DETAILED DESCRIPTION

ONLINE DOCTORS APPOINTMENT is a real-time web based application. The application can be run using internet, intranet, etc. Office staff, patient, People can make doctors appointment 24 hours a day and 7 days a week. People can pick the desired day and time from doctor appointment calendar. Office staff can also make appointment during office hours. It is user friendly and little knowledge of web browsing can make doctors appointment.

The application consists of three main sections.

Section 1 (Main):

This is the starting point of the application. From here different users can go to the required section. New patient first get register with the office before using the protected section. Register patient can login by using user name and password. Only the valid personal are allowed to the patient section. Office staff can login by using user name and password the application will validate the username and password before going to the doctors section. General area is not protected like Contact information, Assist me, and about doctor.

Section 2 (Patient):

This is the starting point for register user after validating the user name and password. Register users can do different actions. Modify/Edit the register user information like address, home/work/cell/pager number change, email, Insurance information, and other information. Register users can view the current appointment(s). Cancel appointment. Make new appointment. General area are logout, Contact information, Assist me, and about doctor.

Section 3 (office):

This is the starting point for office staff only the authenticated staff can come to this section. From here the office staff can go to the different area. Modify/Edit the office information like telephone number change, address, etc. Modify/Edit the doctor information like telephone number change, specialty, etc. View the current appointment(s). Cancel appointment. Make new appointment. Print doctor appointment for a particular day. General area are logout, Contact information, Assist me, and about doctor.

I am claming the “ONLINE DOCTORS APPOINTMENT” computer application in general and particularly the following:

1. I am claming the “online doctors appointment” computer application in general and particularly the following:
Secure or un-secure algorithms used for manipulating patient or doctor or calendar information on internet, intranet, etc. If user or person or patient is using the application.
Secure or un-secure algorithms used for manipulating patient or doctor or calendar information on internet, intranet, etc. used by the office staff.
Logic, algorithms, computer program, store procedures used to retrieved, update, insert, delete data to or from database.
